(19) United States
(12) Patent Application Publication
(10) Pub. No.: US 2009/0147237 A1
(43) Pub. Date: Jun. 11, 2009

(54) Spatial Phase Feature Location

(75) Inventors: Philip D. Schumaker, Austin, TX (US); Babak Mokaberi, Cedar Park, TX (US); Tom H. Rafferty, Austin, TX (US)

Correspondence Address: MOLECULAR IMPRINTS, PO BOX 81536, AUSTIN, TX, 78708-1536, US

(73) Assignee: Molecular Imprints, Inc., Austin, TX (US)

(21) Appl. No.: 12/328,327

(22) Filed: Dec. 4, 2008

Related U.S. Application Data
(60) Provisional application No. 60/992,416, filed on Dec. 5, 2007.

(51) Int. Cl. G01B 11/00; G03B 27/58

(52) U.S. Cl. 355/72; 356/401

(57) ABSTRACT

Methods for locating an alignment mark on a substrate are described. Generally, the substrate includes one or more locator marks adjacent to a substrate alignment mark. Locator marks provide the relative location of the substrate alignment mark such that the substrate alignment mark may be used in aligning a substrate with a template within a lithographic system with a reduced magnitude of relative displacement.

### CROSS-REFERENCE TO RELATED APPLICATION

This application claims the benefit under 35 U.S.C. §119(e)(1) of U.S. Provisional No. 60/992,416, filed on Dec. 5, 2007, which is hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent includes formation of a relief pattern in a formable layer (polymerizable) and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3A illustrates a simplified elevation view of a template in superimposition with a substrate, showing misalignment along one direction.

FIG. 3B illustrates a top down view of a template in superimposition with a substrate, showing misalignment along two transverse directions.

FIG. 3C illustrates a top down view of a template in superimposition with a substrate, showing angular misalignment.

FIG. 4A illustrates a simplified top down view of an exemplary alignment system having multiple alignment measurement units about a field.

FIG. 4B illustrates a simplified top down view of a substrate.

FIG. 5A illustrates exemplary locator marks adjacent to a template alignment mark.

FIGS. 5B-5D illustrate exemplary locator marks adjacent to substrate alignment marks.

FIG. 6 illustrates a flow chart of an exemplary method for identifying pixel location of locator marks in an image frame.

FIG. 7 illustrates a flow chart of another exemplary method for identifying pixel location of locator marks in an image frame.

FIG. 8 illustrates a flow chart of an exemplary method for aligning a template with a substrate using locator marks.

### DETAILED DESCRIPTION

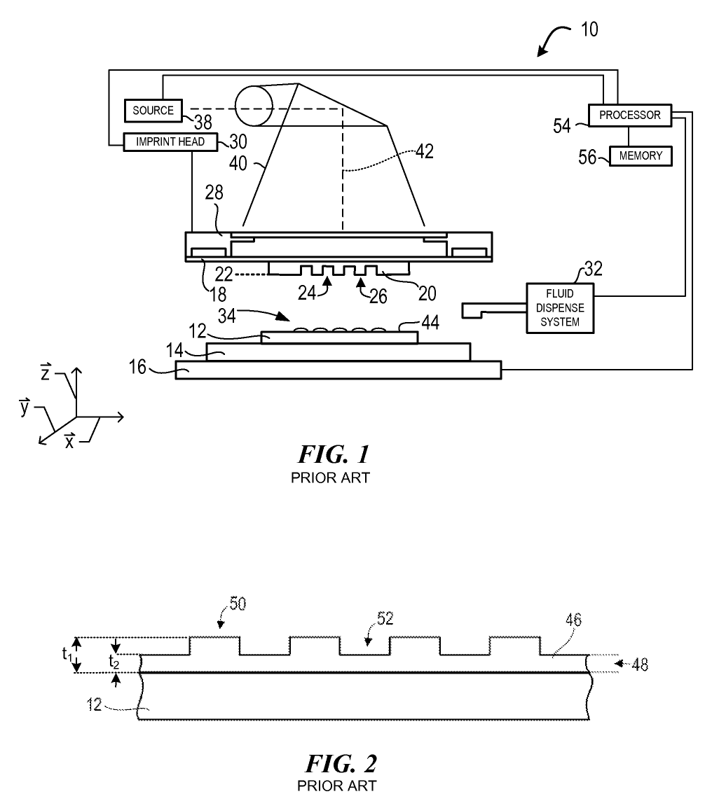

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference.

Substrate 12 and substrate chuck 14 may be further supported by stage 16. Stage 16 may provide motion along the x-, y-, and z-axes. Stage 16, substrate 12, and substrate chuck 14 may also be positioned on a base (not shown).

Spaced-apart from substrate 12 is a template 18. Template 18 may include a mesa 20 extending therefrom towards substrate 12, mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may comprise a monomer mixture as described in U.S. Pat. No. 7,157,036 and U.S. Patent Publication No. 2005/0187339, all of which are hereby incorporated by reference.

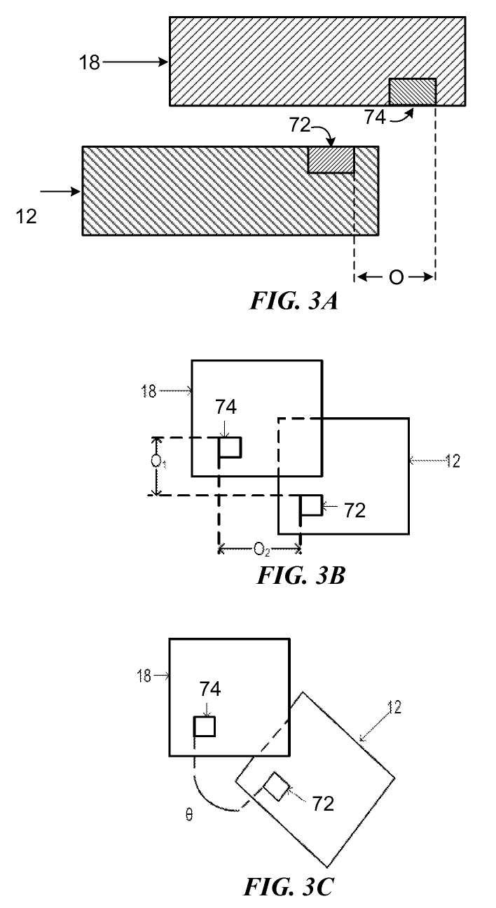

Referring to FIGS. 1 and 2, system 10 may further comprise an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having thickness t₁ and residual layer having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

Ascertaining a desired alignment between template 18 and substrate 12 may aid in the facilitation of pattern transfer between template 18 and substrate 12. Referring to FIG. 3A, it is assumed that desired alignment between template 18 and substrate 12 occurs upon alignment mark 74 of the template 18 being in superimposition with alignment mark 72 of the substrate 12. For example, in FIG. 3A, desired alignment between template 18 and substrate 12 has not occurred, shown by the two marks being offset a distance O. Further, although offset 0 is shown as being a linear offset in one direction, it should be understood that the offset may be spanned along two directions shown as O₁ and O₂ as shown in FIG. 3B. In addition to, or instead of, the aforementioned linear offset in one or two directions, the offset between template 18 and substrate 12 may also consist of an angular offset, shown in FIG. 3C as angle Θ. Multiple alignment marks when added to template 18 and substrate 12 may also show other misalignment terms in combination (e.g., magnification, skew, trapezoidal distortions, and the like).

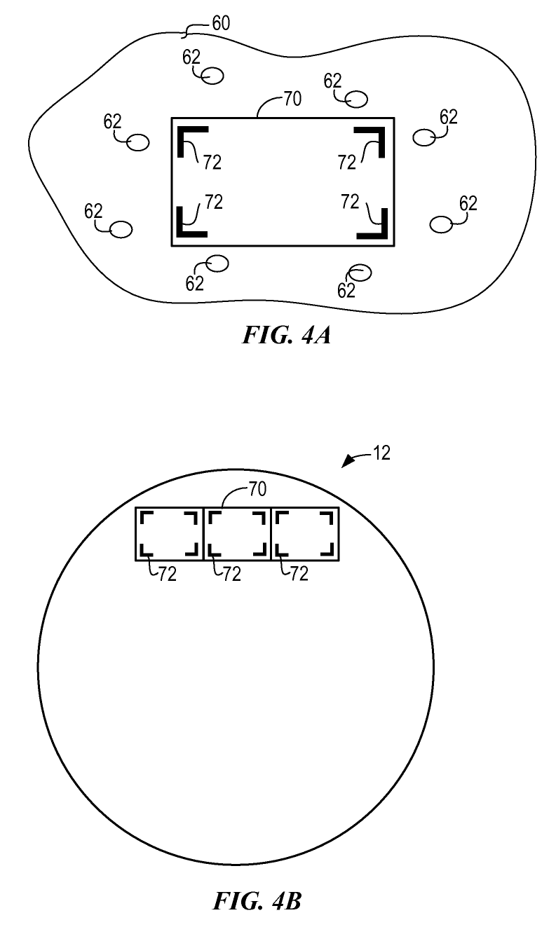

Referring to FIGS. 4A and 4B, to facilitate alignment, an alignment system 60 utilizing alignment marks 74 on the template 18 and alignment marks 72 on substrate 12 may be used. FIG. 4A illustrates a simplified view of an alignment system 60 having multiple alignment measurement units 62 (e.g., microscopes). Examples of alignment marks 74 and/or 72 and alignment systems 60 for use in imprint lithography processes are described in detail in U.S. Pat. No. 7,136,150, U.S. Pat. No. 7,070,405, U.S. Pat. No. 6,916,584, and U.S. Patent Publication No. 2007/0231421, all of which are hereby incorporated by reference.

The alignment system 60 may be used for a field-by-field alignment process. As illustrated in FIGS. 1, 4A-4B, and 5A-C, during imprinting, the stage 16 and imprint head 30 may be moved such that template 18 is oriented over the desired field 70 of the substrate 12 based on coordinates stored in a memory 56. Each field 70 of the substrate 12 may include two or more alignment marks 72 that correspond to alignments marks 74 on the template 18. The alignment marks 74 on the template 18 may then be aligned with alignment marks 72 at a specific field 70 being imprinted on the substrate 12 by evaluation of moiré patterns as described in U.S. Publication No. 2004/0189996, which is hereby incorporated by reference. Once the field 70 is imprinted, stage 16 may be moved to orient template 18 over another field 70 of the substrate 12. As such, alignment may be conducted within individual fields 70 of the substrate 12.

Generally within the present art, the optimal location of the region of interest for moiré fringes is determined manually. Additionally, a lack of a single coordinate system makes alignment complicated as multiple offsets are generally required to align coordinate systems of one camera system to another camera system. Furthermore, these offsets may be sensitive to mechanical drift (e.g., thermal).

In order to provide a suitable location for the region of interest for the moiré fringes, the location of alignment marks 72 and/or 74 on substrate 12 and template 18 respectively may be determined by one or more locator marks 76. For example, by providing the spatial phase location of the locator mark 76 adjacent to alignment mark 72 and/or 74, the relative location of alignment mark 72 and/or 74 may be determined. Generally, the location of locator mark 76 may be determined without the use of a reference image and may be robust to mechanical vibrations that may cause equipment to move with respect to template 18 and/or substrate 12. Additionally, by identifying locator mark 76 on template 18, induced image noise interference, as seen when gases (e.g., helium) alters the index of refraction in the environment of template 18 and substrate 12 may be reduced.

Locator marks 76 may be formed of substantially similar material and in a similar fashion to alignment marks 72 and/or 74. Locator marks 76 are generally located adjacent to alignment marks 72 and 74, may provide for registration of location of alignment marks 72 and/or 74, and further may promote registration of location of alignment marks 72 and/or 74 in situ and in substantially real time. For example, moiré fringes are generally unable to be determined with only the template 18, and not the substrate 12, loaded within lithographic system 10. However, the location of the locator mark 76 on the template 18 may be determined without loading the substrate 12 within the lithographic system 10. As such, the locator mark 76 may be able to provide a relative location of where the moiré fringes may be prior to loading of the substrate 12.

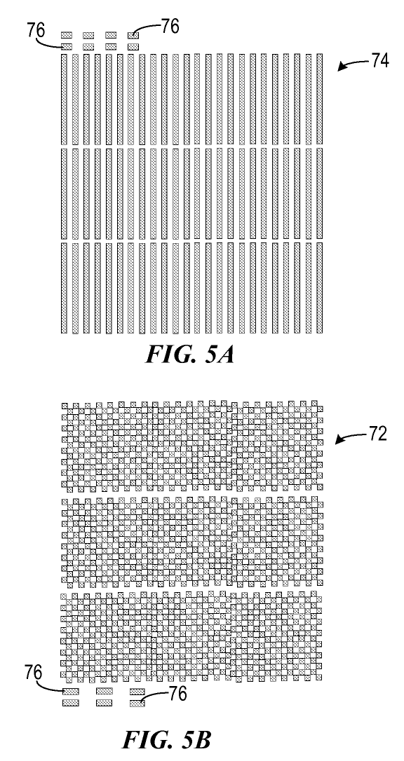

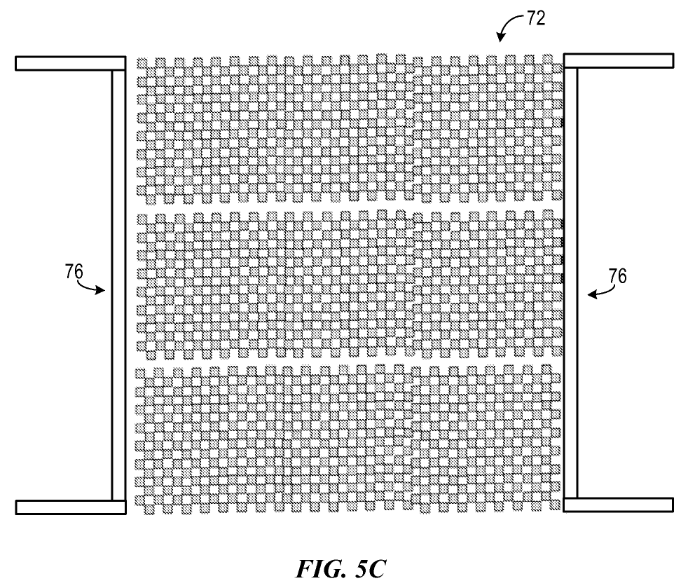

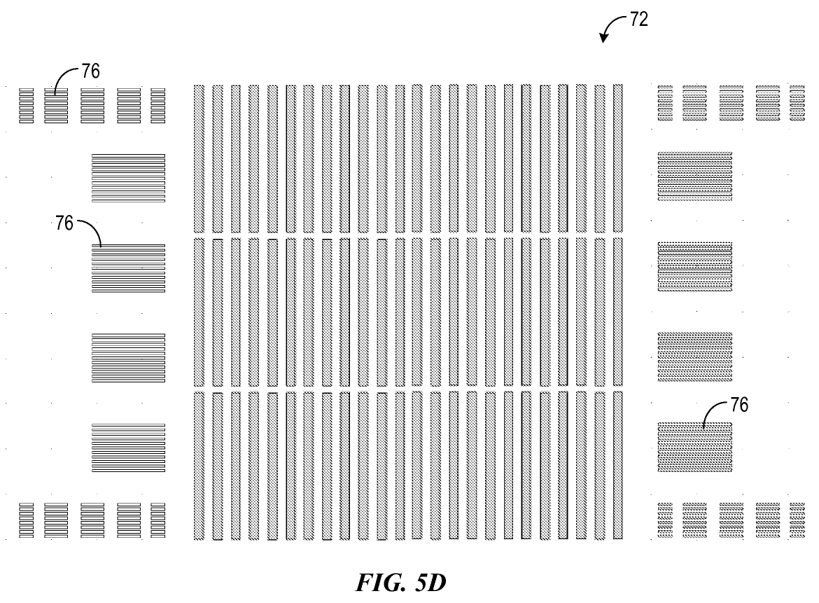

FIG. 5A illustrates the use of six separate locator marks 76 adjacent to a corner region of alignment mark 72. Each locator mark 76 may be defined by a width w and a height h. In a similar fashion, FIG. 5B illustrates the use of six separate locator marks 76 adjacent to a corner region of alignment mark 74. FIG. 5C illustrates the use of two locator marks 76 with each locator mark 76 adjacent to at least one side of alignment mark 72. FIG. 5D illustrates another exemplary embodiment having at least one locator mark 76 adjacent to at least one side of alignment mark 72 and exhibiting periodicity.

It should be noted one or more locator marks 76 on substrate 12 and/or template 18 may be used to identify any region of interest on substrate 12 and/or template 18, and thus locator marks 76 may not be limited in use to location and registration of alignment marks 72 and/or 74. For simplicity of description, however, use of locator marks 76 with alignment mark 72 is described in further detail below.

In general, locator mark 76 may be used with alignment system 60 to provide a locator signal (e.g., sine wave). For example, locator signal may provide a 4 Hz sine wave when processed by alignment system 60. The frequency, phase, and/or amplitude of the locator signal provided by locator mark 76 may be pre-determined. Using the pre-determined locator signal, position of locator marks 76 may be identified within an image frame. Generally, the image frame may be searched to identify the locator signal and thus provide the location of locator mark 76.

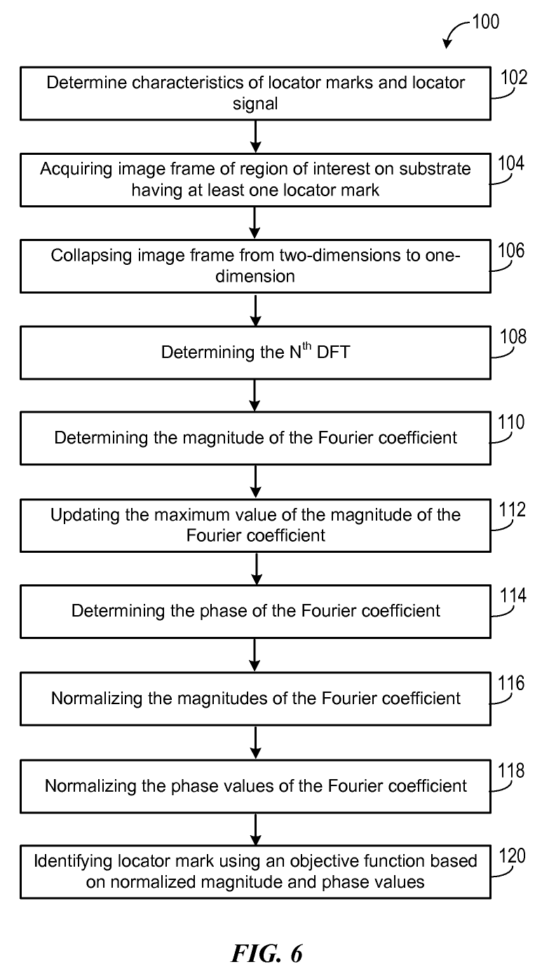

FIG. 6 illustrates a flow chart of an exemplary method 100 for identifying the pixel location of locator marks 76 in the image frame. It should be noted that a portion of the following steps may be provided in MATLAB or other similar computing environments. In a step 102, characteristics of locator marks 76 and characteristics of the locator signal may be determined. For example, the number of periods, the width w of the locator mark 76, and/or the height h of the locator mark 76 may be determined. In a step 104, an image frame of a region of interest of the substrate 12 having locator mark 76 may be acquired. The image frame may be defined by a width W and a height H. For example, the image frame may be W pixels wide and H pixels tall. In a step 106, the image frame of substrate 12 may be collapsed from a two-dimensional image to a one-dimensional vector. For example, the image frame may be collapsed by providing:

strip=avg(r:r+w,c:c+h) (EQ. 1)

wherein:

c=1 to W−w (EQ. 2)

r=1 to H−h (EQ. 3)

as the image frame is W pixels wide and H pixels tall and the locator marks 76 are w pixel wide and h pixels tall.
In a step 108, the N^{th} discrete Fourier transform (dft) may be determined by:

fc=dft(strip,N) (EQ. 4)

In a step 110, the magnitude of the Fourier coefficient may be determined by:

m(r,c)=abs(fc) (EQ. 5)

Generally, the maximum value of the magnitude of the Fourier coefficient mₘₐₓ is initially zero. In a step 112, this value may be continuously updated by determining if m(r,c) is greater than mₘₐₓ. If m(r,c) is greater than mₘₐₓ then mₘₐₓ=m(r,c).
In a step 114, the phase of the Fourier coefficient may be determined by:

p(r,c)=angle(fc) (EQ. 6)

In a step 116, magnitudes (e.g., c=1 to W−w, r=1 to H−h, and m(r,c)) may be normalized to be between 0 and 1. In a step 118, phase values (e.g., c=1 to W−w, r=1 to H−h, p(r,c)) may be normalized to be between 0 and 1. In a step 120, an objective function may be used to identify the locator mark 76 based on normalized magnitude and phase values. For example, locator mark 76 may be identified by determining:

(m(r,c)+p(r,c))>mₘₐₓ (EQ. 7)

such that the pixel location (mr, mc) is generally the location of the locator mark 76 and mr=r and mc=c.

The method 100 shown in FIG. 6 is only one example for identifying the location of locator mark 76 as numerous variants of this procedure may be used. For example, row and column strides may be adjusted to coarsely locate the locator mark 76. Additionally, the objective function may be altered to be biased to optimize for phases other than 0.0, locate portions of locator mark 76 that comprise spatially disparate components, and/or other similar alterations.

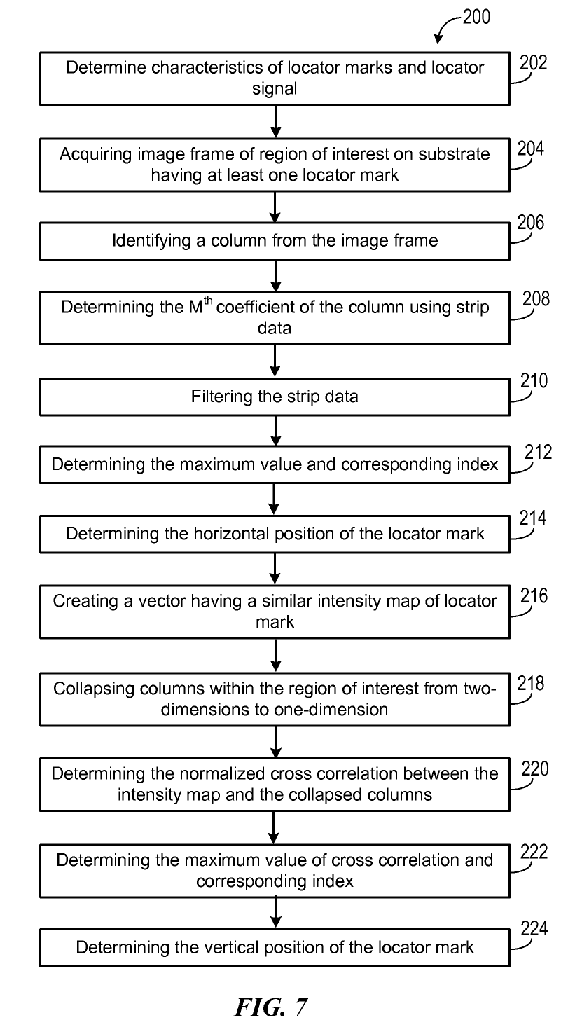

FIG. 7 is a flow chart of another method 200 for identifying the pixel location of locator marks 76 in the image frame. Generally, the dft of the locator mark 76 may be used to determine the location of the locator mark 76 along the periodicity direction. For example, as illustrated in FIG. 5D, locator marks 76 may exhibit periodicity along the vertical and/or horizontal direction. In FIG. 5D, locator marks 76 exhibit periodicity along the vertical direction (e.g., approximately 5 periods). The magnitude of dft may be maximized at this periodicity. As such, location of the horizontal location of each locator mark 76 may be determined for a given image frame. In addition, the location of the locator mark 76 may be determined by maximizing a cross correlation function between the locator mark 76 and its one dimensional intensity map. For example, the cross correlation function may be used to locate the vertical position (e.g., Y position) of each locator mark 76. Generally, the locator mark 76 spans at least one side of alignment mark 72 (e.g., locator marks 76 illustrated in FIGS. 5B and 5D).

In a step 202, characteristics of locator marks 76 and characteristics of the locator signal may be determined. For example, the number of periods, the width w of the locator mark 76, and/or the height h of the locator mark 76 may be determined. In a step 204, an image frame of a region of interest of the substrate 12 having locator mark 76 may be acquired. The image frame may be defined by a width W and a height H. For example, the image frame may be W pixels wide and H pixels tall. In a step 206, a column c may be identified from the image frame. In a step 208, the m^{th} dft coefficient of column c may be determined by:

col=column c from image (EQ. 8)

fc=dft(col,m) (EQ. 9)

strip(c)+=abs(fc) (EQ. 10)

wherein:

binMax=round(H/Np)+1 (EQ. 11)

strip(1:W)=0 (EQ. 12)

for m=binMax−4 to binMax+4

wherein Np is the number of pixels period of locator mark 76 along its periodicity direction (e.g. vertical direction in FIG. 5D).

In a step 210, strip data may be filtered. For example, strip data may be filtered by a moving average window with uniform unity weights and length. In a step 212, the maximum value (mv) of filtered strip data and the corresponding index (cmax) may be determined. In a step 214, the horizontal position of the locator mark 76 may be determined as:

mc=cmax (EQ. 13)

In a step 216, geometry of the locator mark 76 may be used to create a vector T(1:h) with the similar intensity map of the locator mark 76 along the periodicity direction. In a step 218, columns within the region of interest may be collapsed to a one dimensional vector. In a step 220, the one-dimensional normalized cross correlation between the intensity map and the collapsed columns may be determined. In a step 222, the maximum value of cross correlation and the corresponding index may be determined. In a step 224, the vertical position of the locator mark 76 may be determined from the maximum value occurrence index.

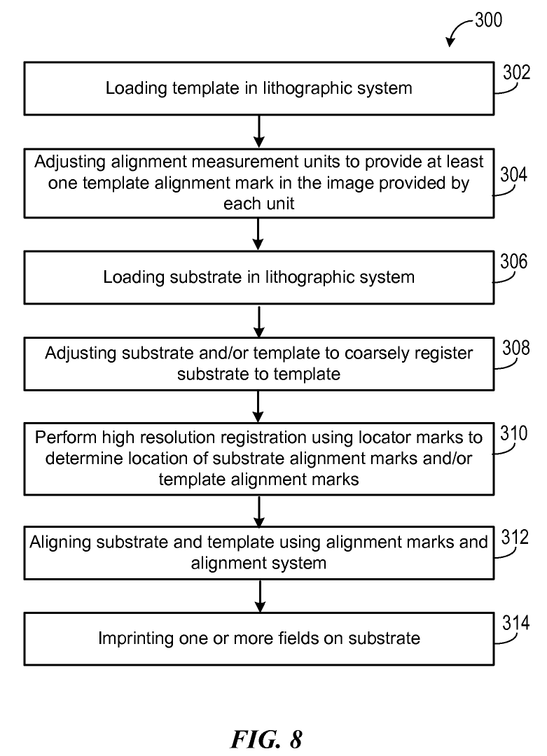

FIG. 8 illustrates a flow chart of an exemplary method 300 for alignment of template 18 with substrate 12 using at least one locator mark 76. In a step 302, template 18 may be loaded in lithographic system 10. In a step 304, multiple alignment measurement units 62 may be adjusted to provide at least one alignment mark 74 in the image provided by each alignment measurement unit 62. For example, multiple alignment measurement units 62 may be adjusted to provide at least one alignment mark 74 of template 18 in the upper left corner of the image provided by each alignment measurement unit 62. In a step 306, substrate 12 may be loaded in lithographic system 10. In a step 308, substrate 12 and/or template 18 may be adjusted to coarsely register (e.g., place into superimposition) the template 18 to the substrate 12. In a step 310, high resolution registration may be performed using locator marks 76 to determine location of alignment marks 72 and/or 74. High resolution registration may provide relative displacement of substrate 12 to template 18 with an approximate 10 nm accuracy. In a step 312, substrate 12 and template 18 may be aligned using alignment marks 72 and/or 74, and alignment systems 60 as described in detail in U.S. Pat. No. 7,136,150, and U.S. Pat. No. 7,070,405, U.S. Pat. No. 6,916,584, and U.S. Patent Publication No. 2007/0231421, all of which are hereby incorporated by reference. In a step 314, fields may be imprinted on substrate 12 using systems and processes as described in U.S. Pat. No. 6,932,934, U.S. Patent Publication No. 2004/0124566, U.S. Patent Publication No. 2004/0188381, and U.S. Patent Publication No. 2004/0211754, all of which are hereby incorporated by reference.

What is claimed is:

1. A method for aligning a template with a substrate within a lithographic system, the template having a mold, a plurality of alignment marks, and a plurality of locator marks, the method comprising:
positioning template within lithographic system, lithographic system comprising an alignment system having a plurality of adjustable alignment measurement units;
providing, by at least one alignment measurement unit, an image frame;
adjusting the alignment measurement unit to provide at least one template alignment mark and one template locator mark within the provided image frame;
positioning substrate within lithographic system such that substrate is in superimposition with template;
determining location of locator mark within the image frame to provide location of template alignment mark; and,
aligning template to substrate using template alignment mark.

2. The method of claim 1 wherein determining location of locator mark within the image frame includes determining location of locator mark in a periodicity direction.

3. The method of claim 2 wherein determining location of locator mark in the periodicity direction includes maximizing a cross correlation function between locator mark and a one dimensional intensity map obtained from locator mark.

4. The method of claim 1 wherein determining location of locator mark within the image frame further comprises:
identifying a horizontal position of locator mark; and,
identifying a vertical position of locator mark.

5. The method of claim 1 wherein determining location of locator mark within the image frame includes determining a pixel location of locator mark within image frame.

6. The method of claim 1 wherein adjusting the alignment measurement unit to provide at least one template alignment mark and one template locator mark within the provided image frame occurs prior to positioning substrate within lithographic system.

7. The method of claim 1 further comprising positioning polymerizable material between template and substrate.

8. The method of claim 7 further comprising solidifying polymerizable material.

9. The method of claim 1 wherein determining location of locator mark within the image frame provides location of edge of template alignment mark.

10. The method of claim 1 wherein determining location of locator mark within the image frame to provide location of template alignment mark occurs prior to positioning substrate within lithographic system.

11. A method for locating an alignment mark on a template, the template having a plurality of locator marks adjacent to the alignment mark, the method comprising:
positioning template within a lithographic system, lithographic system comprising an alignment system having a plurality of adjustable alignment measurement units;
providing, by at least one alignment measurement unit, an image frame;
adjusting the alignment measurement unit to provide at least one template alignment mark and at least one template locator mark within the provided image frame; and,
determining location of template locator mark within the image frame to provide relative location of template alignment mark.

12. The method of claim 10 wherein determining location of template locator mark within the image frame includes determining pixel location of template locator mark.

13. The method of claim 10 wherein determining location of template locator mark within the image frame includes determining location of template locator mark in a periodicity direction.

14. The method of claim 10 wherein determining location of template locator mark in the periodicity direction includes maximizing a cross correlation function between template locator mark and a one dimensional intensity map obtained from template locator mark.

15. The method of claim 10 further comprising:
loading a substrate within lithographic system, template being in superimposition with substrate,
wherein determining location of template locator mark within the image frame to provide relative location of template alignment mark provides relative location of an anticipated moiré fringe prior to loading of substrate within lithographic system.

16. The method of claim 10 wherein the template is an imprinting template.

17. A method for aligning a template with a substrate within a lithographic system, the substrate having plurality of alignment marks, and a plurality of locator marks, the method comprising:
positioning template within lithographic system, lithographic system comprising an alignment system having a plurality of adjustable alignment measurement units;
providing, by at least one alignment measurement unit, an image frame;
adjusting the alignment measurement unit to provide at least one template alignment mark and one template locator mark within the provided image frame;
positioning substrate within lithographic system such that an imprinting template is in superimposition with substrate, the substrate having multiple substrate alignment marks;
determining location of locator mark of template within the provided image frame;
determining magnitude of relative displacement of at least one substrate alignment mark to at least one template alignment mark using location of locator mark within the provided image frame;
adjusting substrate to substantially eliminate magnitude of relative displacement; and,
aligning template to substrate using template alignment marks and substrate alignment marks.

18. The method of claim 17 wherein determining location of locator mark within the image frame includes determining location of locator mark in a periodicity direction.

19. The method of claim 18 wherein determining location of locator mark in the periodicity direction includes maximizing a cross correlation function between locator mark and a one dimensional intensity map obtained from locator map.

20. The method of claim 17 further comprising positioning polymerizable material between template and substrate.

21. The method of claim 20 further comprising solidifying polymerizable material.
